(19) United States
(12) Patent Application Publication
(10) Pub. No.: US 2002/0180647 A1
(43) Pub. Date: Dec. 5, 2002

(54) Low profile, planar, slot antenna

(76) Inventor: Paul A. Nysen, Sunnyvale, CA (US)

Correspondence Address: MILDE, HOFFBERG & MACKLIN, LLP, SUITE 460, 10 BANK STREET, WHITE PLAINS, NY, 10606, US

(21) Appl. No.: 09/873,573

(22) Filed: Jun. 4, 2001

(51) Int. Cl. H01Q 1/24

(52) U.S. Cl. 343/702

(57) ABSTRACT

A low profile, planar antenna comprises a substantially rectangular, electrically conductive, planar, first antenna element having two planar face sides and an outer circumferential edge and an electrically conductive, planar, second antenna element, of substantially the same shape and size as the first antenna element, also having two planar face sides and an outer circumferential edge. The second antenna element is disposed adjacent to and parallel with the first antenna element with the respective edges of the first and second antenna elements in substantial alignment. A first electrically conductive element is connected between two adjacent edges of said first and second antenna elements and a coupling element is provided for applying RF energy to the first antenna element at a feed point thereon. The space between adjacent edges of the first and second antenna elements forms a slot and emits radiation outward primarily in a plane parallel to the two planes of the first and second antenna elements and with a polarization in the E field substantially normal to such two planes.

### BACKGROUND OF THE INVENTION

The present invention relates to a low profile, planar, slot antenna which is capable of radiating substantially omnidirectionally in the horizontal plane. This antenna is particularly adapted for use with a Personal Computer Memory Card International Association (“PCMCIA”) interface card.

Electronic circuit cards, which contain communications devices such as modems and pagers, are used with portable terminals such as portable computers, laptop computers, personal digital assistants (PDA's) and Internet appliances to allow data transfer and communication between the portable terminal and a wireless network. A common form for these circuit cards is a modular unit that may be plugged into a slot on a host terminal and, in addition, easily unplugged and removed for transportation or easily changed to allow communication with different wireless networks.

One widely used standard that defines a 68 pin interface and slot and assembly dimensions for the interface between an electronic circuit card and a host terminal has been established by the Personal Computer Memory Card International Association (“PCMCIA”). Circuit cards which conform to this standard are known PCMCIA cards.

When a circuit card such as a PCMCIA card is used for data transfer and communication between a host terminal and a wireless network, it is necessary that some sort of antenna be provided. Such an antenna should have dimensions which are commensurate with the standardized dimensions of the PCMCIA card. Ideally, the antenna should form a integral part of the PCMCIA card package so that it is not easily damaged or broken, either when in use with a host terminal or when transported with the PCMCIA card.

Also, advantageously, the antenna should provide a substantially omnidirectional radiation pattern in the horizontal plane when the PCMCIA card, to which it is attached, is inserted into a horizontal slot in a host terminal.

Finally, the antenna should be configured to receive or transmit on the frequency bands of the wireless network that the PCMCIA card is designed to communicate with. Advantageously, these frequency bands include the bands allocated to code division multiple access (CDMA) digital wireless communication, a wide area network (WAN) technology developed by Qualcomm Inc. of San Diego, Calif.

Various antennas have been especially designed for PCMCIA cards. Examples are found in the U.S. Pat. Nos. 5,646,635; 5,918,163; 5,949,379 and 6,172,645. These prior known antennas are either moveable or extendible with respect to the PCMCIA card and are therefore neither user friendly nor mechanically robust during operation.

### SUMMARY OF THE INVENTION

A principal object of the present invention, therefore, is to provide an antenna which may be mechanically integrated into a PCMCIA card.

A further object of the present invention is to provide an antenna for a PCMCIA card which is optimized for the 1900 MHz band of frequencies—e.g., the 1850 to 1990 MHz band—and has sufficient bandwidth e.g., 140 MHz—to cover the selected band.

A further object of the present invention is to provide an antenna for a PCMCIA card which radiates substantially omnidirectionally in the horizontal plane when the PCMCIA card, to which it is attached, is inserted in a horizontal slot in a host terminal.

It is a further object of the present invention to provide a vertically polarized antenna for a PCMCIA card which is no thicker than a standard PCMCIA.

It is a further object of the present invention to provide an antenna for a PCMCIA card which is mechanically robust.

A further object of the present invention is to provide an antenna for a PCMCIA card which does not require manipulation by a user during operation.

These objects, as well as other objects which will become apparent from the discussion that follows, are achieved, in accordance with the present invention, by providing a substantially symmetrical antenna structure, comprising two planar, substantially identical, electrically conductive, antenna elements, arranged side by side and in parallel, forming a “slot” between them; an electrically conductive element connected between two adjacent edges of the antenna elements; and a coupling element for supplying RF energy to a feed point between the two antenna elements. Upon application of the RF energy, this antenna structure emits radiation outward from the slot primarily in a direction parallel to the planes of the antenna elements with a polarization in the E field substantially normal to the two planes.

Conversely, this antenna structure functions as a receiving antenna to receive radiation and supply it at the feed point to the coupling element.

Although the antenna structure, as described above, is superficially similar to that of a known “patch” antenna, it is a significant departure, in both structure and operation, from the patch antenna. The antenna structure according to the invention is symmetrically balanced and, as such, has no ground plane as is required for a patch antenna. Furthermore, it radiates primarily in a plane which is parallel to the planar antenna elements, whereas a patch antenna radiates primarily in a direction perpendicular to the planar “patch”.

The two planar antenna elements in the antenna structure according to the invention each have two planar face sides and an outer circumferential edge. The two antenna elements are adjacently disposed so that their respective edges are in substantial alignment.

In order to conform the antenna in shape and size to the PCMCIA card, the antenna elements are preferably in the shape of a rectangular parallelepiped. In particular, each of the antenna elements is in the shape of a rectangle having two short parallel edges and two long parallel edges.

Preferably also, the long edges of the antenna elements are substantially twice the length of the short edges thereof.

Preferably also, the short edges of the two antenna elements have a length which is approximately one-quarter of the wavelength of the radiation in free space at the frequency of the RF energy.

Advantageously, the electrically conductive element is connected between a long edge of one of the antenna elements and a long edge of the other antenna element.

In a preferred embodiment of the present invention, the electrically conductive element is a planar member that extends between the edge portions of the two antenna elements in substantially perpendicular relationship thereto. This planar member can extend between the two antenna elements for the entire length of the two long straight edges thereof or for less than the entire length of these two long straight edges. In the latter case, the planar member is preferably disposed substantially midway between the opposite ends of the two adjacent edges.

Advantageously, the electrically conductive element is adjusted by width to cause the antenna to be at or near resonance for a particular order of resonant mode. Such adjustment of the electrically conductive element varies the resonant frequency of the antenna.

The coupling element, which supplies the RF energy to one of the antenna elements, preferably provides a ground connection to the other antenna element. The feed point to which the RF energy is supplied is preferably a point of low electric field between the two antenna elements. For example, the feed point may be substantially at the center of one of the antenna elements or adjacent to an edge of one of the antenna elements. In the latter case, the feed point is preferably adjacent to an edge of one of the antenna elements which is opposite to the edge to which the first electrically conductive element is attached.

The coupling element may be any one of a number of coupling elements known in the art such as a strip line, a magnetic coupling, a loop or a hook. Advantageously, the coupling element includes at least one impedance matching element which matches the impedance of the source of RF energy to that of the antenna over the frequency band of the RF energy that is applied.

To render the antenna more mechanically robuts, a dielectric material such as a plastic foam may be disposed on the space between the two antenna elements.

According to preferred embodiments of the invention, the bandwidth of the antenna may be increased in a number of different ways:

In a first embodiment, one or both of the antenna elements may include a longitudinal slot extending perpendicular or parallel to the edge to which the electrically conductive element is connected. In a second embodiment, the planar member forming the electrically conductive element itself includes a longitudinal slot extending parallel to the edge of the two antenna elements to which it is connected. The slot may be rectangular or, advantageously, the slot may be wider at its two extremities than at its center.

In another embodiment, at least one coplanar resonant element, and preferably two or more coplanar resonant elements, are placed in the proximity of the edge of one or both of the antenna elements to increase the bandwidth of the antenna. Such resonant elements may be selected so as to provide a multi-band antenna.

Finally, in addition to the two parallel planar antenna elements, the antenna may combine two more or even four more parallel planar antenna elements of substantially the same shape and size with their edges disposed in alignment. In such a case, a second, electrically conductive element is connected between two adjacent edges of the third and fourth planar antenna elements which are arranged on opposite sides of the first two antenna elements and a third electrically conductive element is connected between the adjacent edges of the fifth and sixth antenna elements, which are arranged on opposite sides of the third and fourth elements. All of the electrically conductive elements are preferably disposed adjacent to each other on the same side of the antenna.

### BRIEF DESCRIPTION OF THE DRAWINGS

FIG. 1 is a representative diagram showing various uses of a PCMCIA card.

FIG. 2 is a perspective view of a rectangular PCMCIA card, showing the exact dimensions of the card.

FIG. 3 is a side view of a PCMCIA card inserted into a lap top computer illustrating the ideal radiation pattern for its antenna.

FIG. 4 is a top view of a PCMCIA card illustrating the ideal radiation pattern for its antenna.

FIG. 5 is a perspective view of the antenna structure according to one preferred embodiment of the present invention.

FIG. 6 is a top view of the antenna structure of FIG. 5.

FIG. 7 is a side view of the antenna structure of FIG. 5.

FIG. 8 is an equivalent circuit of the antenna structure of FIG. 5.

FIG. 9 is a side view of an antenna incorporating foam between the antenna elements according to another preferred embodiment of the present invention.

FIG. 10 is a top view of the antenna structure of FIG. 9.

FIG. 11 is a side view of the antenna structure of FIG. 9 showing the layered structure of the foam.

FIG. 12 is a perspective view of an antenna according to another preferred embodiment having a conductive element with two longitudinal slots.

FIG. 13 is a perspective view of an antenna according to still another preferred embodiment of the invention wherein both the conductive element and the antenna elements incorporate slots.

FIG. 14 is a side view of the antenna structure of FIG. 13.

FIG. 15 is a perspective view of an antenna structure according to still another embodiment of the invention with four antenna elements arranged in parallel.

FIG. 16 is a side view of the antenna structure of FIG. 15.

FIG. 17 is a side view of an antenna structure having six antenna elements arranged in parallel.

FIG. 18 is a top view of an antenna element having rectangular corners.

FIG. 19 is a top view of an antenna element with rounded corners.

FIG. 20 is a top view of a circular antenna element.

### DESCRIPTION OF THE PREFERRED EMBODIMENTS

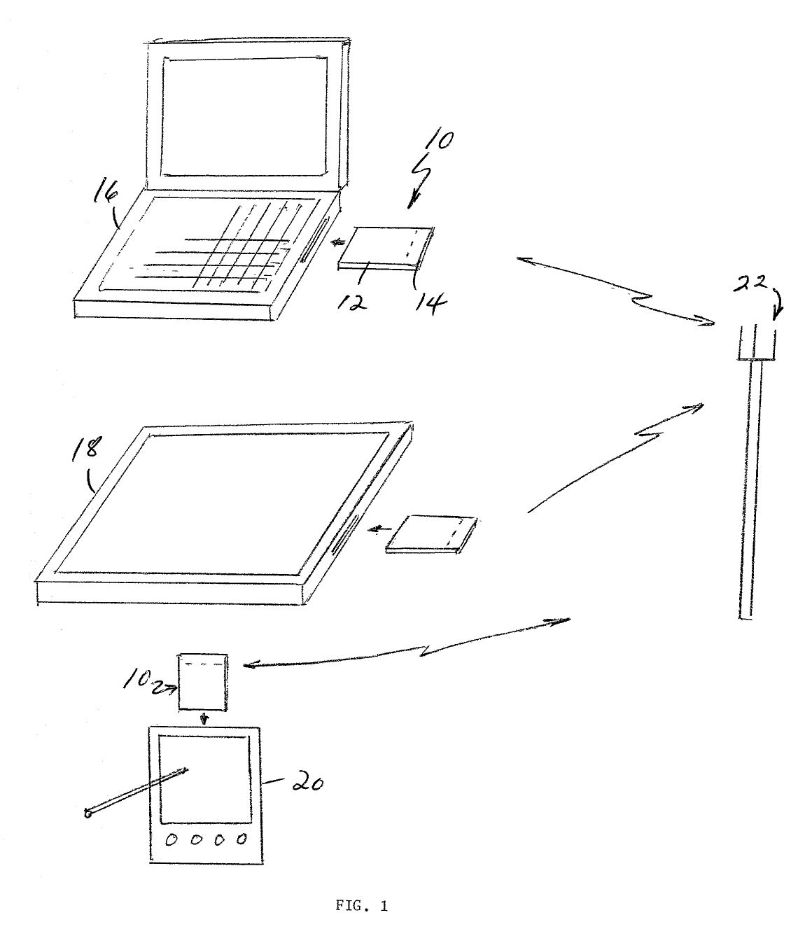

The preferred embodiments of the present invention will now be described with reference to FIGS. 1-20 of the drawings. Identical elements in the various figures are designated with the same reference numerals.

FIG. 1 illustrates an advantageous environment for the low profile, planar, slot antenna according to the present invention. This figure shows a PCMCIA card 10 comprising an electronic circuit portion 12 and an antenna portion 14 insertable into a slot in a number of host terminals: a lap top computer 16, an Internet appliance 18 and a personal digital assistant 20 (PDA or palm computer). These PCMCIA cards 10 facilitate communication with a wireless network, represented by the cellular telephone system antenna 22.

Advantageously, the PCMCIA card 10 with its antenna 14, communicates on either an 800 MHz band or a 1900 MHz band, which have been allocated to code division multiple access (CDMA) digital wireless communication.

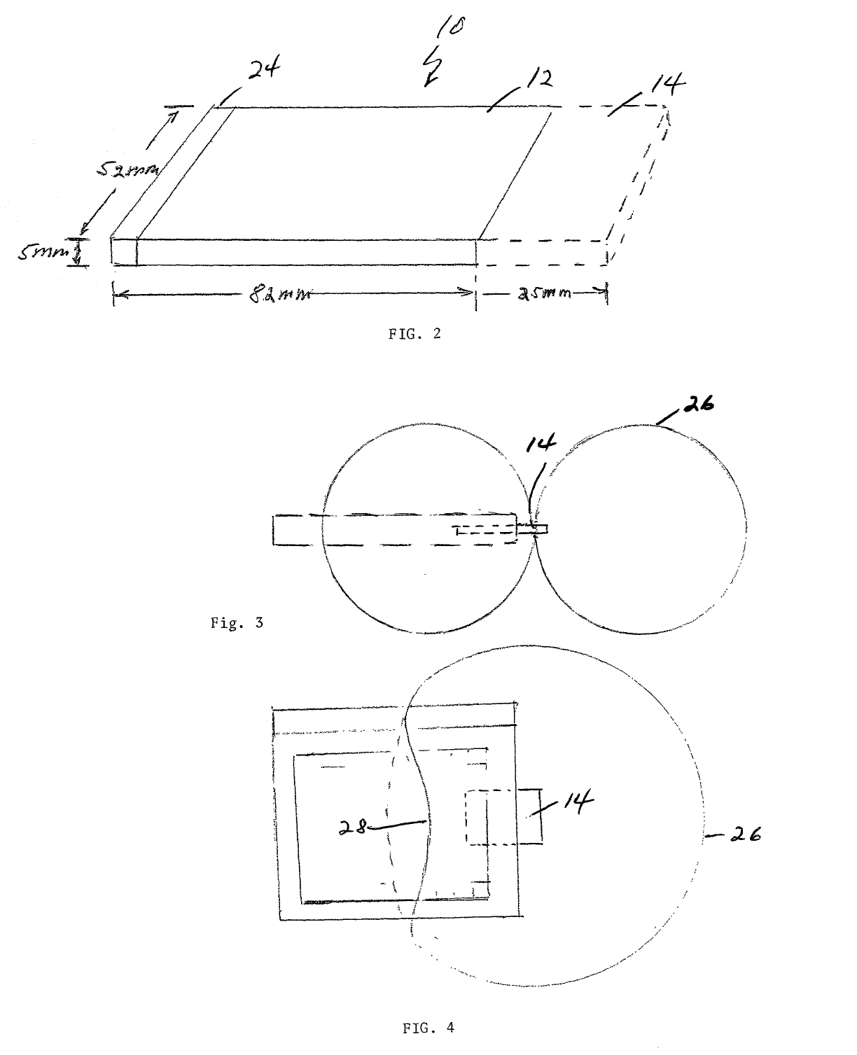

FIG. 2 shows the actual dimensions of a PCMCIA card. These are 52 mm wide, 82 mm long and 5 mm thick. One end of the card is provided with a 68 pin connector 24 for connection to a host terminal. The opposite end of the PCMCIA card, which extends out from the host terminal when the card is inserted into the PCMCIA slot, is provided with an antenna 14 according to the present invention. Ideally, this antenna is contained in the same plastic package as the PCMCIA card and extends outward about 25 mm from the end of the card.

FIGS. 3 and 4 illustrate the ideal radiation pattern for the antenna 14 of FIG. 2. When the card 10 is inserted in a slot in a host terminal, and the antenna portion 14 projects outward horizontally from the side of the terminal, the beam pattern 26 should be +/−2dB omnidirectional in the horizontal plane. Since the host terminal itself will shield the antenna somewhat, the pattern will exhibit a slight deviation from circular as indicated by the indentation 28 in FIG. 4.

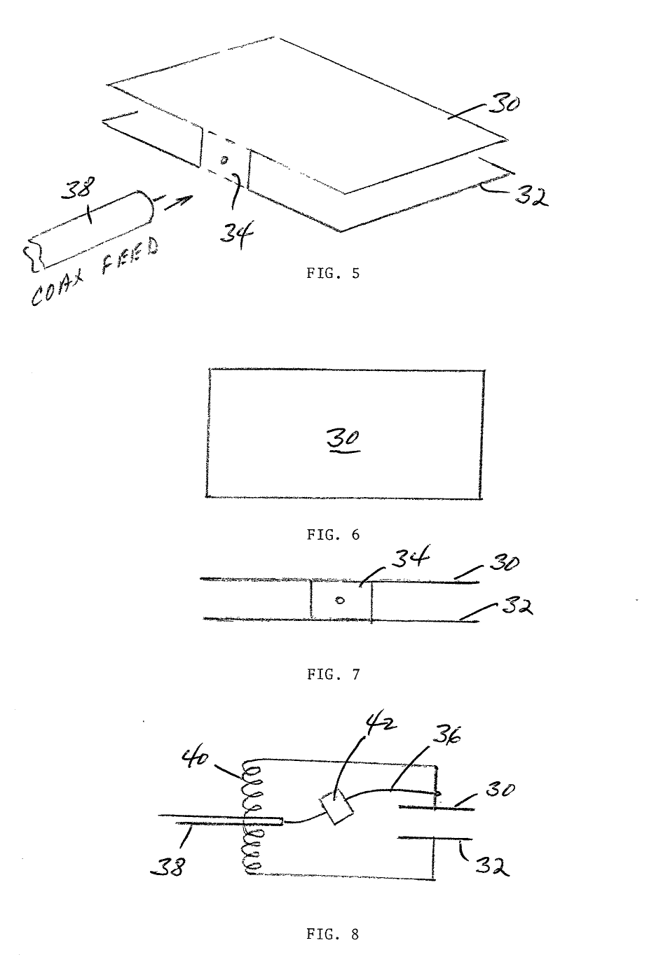

FIGS. 5-8 illustrate the essential elements of the low profile, planar, slot antenna according to the invention. As is there shown, the antenna comprises two electrically conductive, planar antenna elements 30 and 32 having substantially the same shape and size. An electrically conductive element 34 is connected between two adjacent edges of the antenna elements 30 and 32. A coupling element 36 supplied by a coaxial cable 38 applies RF energy to one of the antenna elements 30 at a feed point thereon.

Preferably, this feed point is a point on the antenna element 30 of low electric field between the two antenna elements. For example, the feed point may be at substantially the center of the antenna element 30 or at an edge of the antenna element 30 which is opposite to the edge to which the conductive element 34 is attached.

FIG. 8 illustrates an equivalent circuit for the antenna structure of FIGS. 5-7. This circuit includes the antenna elements 30 and 32 which exhibit capacitance, and the electrically conductive element and the coupling element which exhibit inductance 40. Advantageously, the capacitance and inductance are substantially balanced. Also advantageously, the coupling element includes an element 42 which matches the impedance of the RF source to the antenna.

The coupling element employed with this antenna may be a strip line, a magnetic coupling, a loop or a hook, all of which are well known in the art.

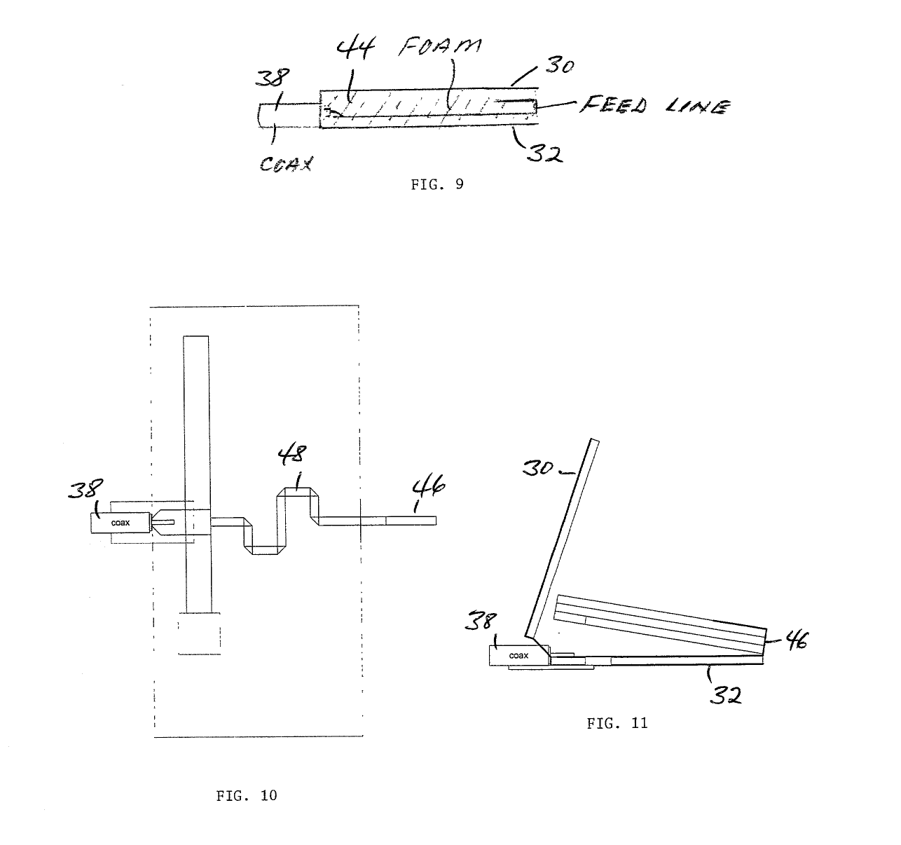

FIGS. 9-11 illustrate another preferred embodiment wherein dielectric material such as plastic foam 44 is disposed in the space between the antenna elements 30 and 32. The plastic foam serves not only to adjust the capacitance of the antenna but also to mechanically support the antenna elements 30 and 32.

FIG. 10 illustrates how a strip line coupling element 46 may be provided with an inductive section 48 for purposes of impedance matching.

FIG. 11 shows how the antenna may be constructed with layers of plastic foam material to support the feed line 46.

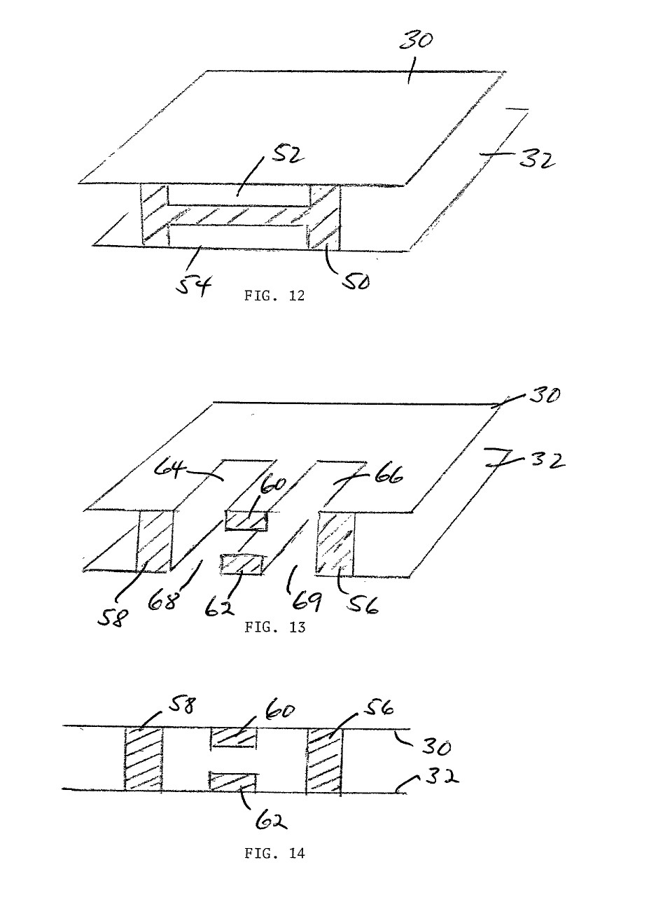

FIG. 12 illustrates how an electrically conductive element 50 which is connected between two adjacent edges of the antenna elements 30 and 32 may be modified to increase the bandwidth of the antenna. In FIG. 12, the conductive element 50 has an “H” configuration, forming longitudinal slots 52 and 54 that extend parallel to the edges of the antenna elements.

FIGS. 13 and 14 illustrate still another embodiment wherein the electrically conductive element is formed of four sections 56, 58, 60 and 62, each connected to the edges of one or both of the antenna elements 30 and 32. When viewed from the side (FIG. 14) the electrically conductive elements form a slot in the shape of an “H”. As shown in FIG. 13, the antenna elements 30 and 32 may also be provided with slots 64 and 66 (element 30) and 68 and 69 (element 32) in such a way as to increase the bandwidth of the antenna.

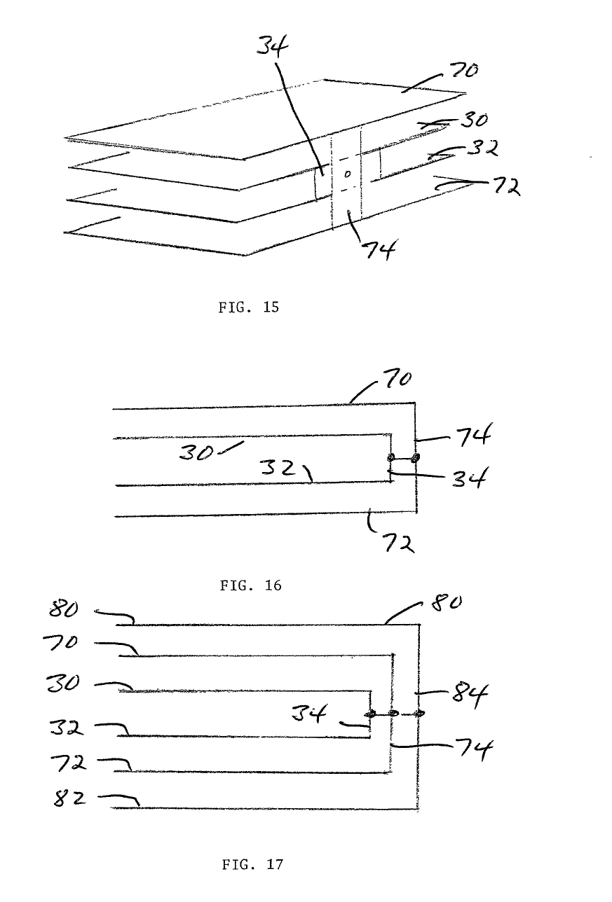

FIGS. 15 and 16 illustrate still another embodiment whereby two additional antenna elements 70 and 72 are provided on opposite sides of the antenna elements 30 and 32, respectively. These additional antenna elements 70 and 72 are also provided with an electrically conductive element 74 connected between two adjacent edges thereof on the same side as the electrically conductive element 34. As indicated in FIG. 16, these electrically conductive elements 34 and 74 are, in turn, electrically connected together.

FIG. 17 illustrates how this principle may be expanded to symmetrically add even more antenna elements 80 and 82 with an associated conductive element 84.

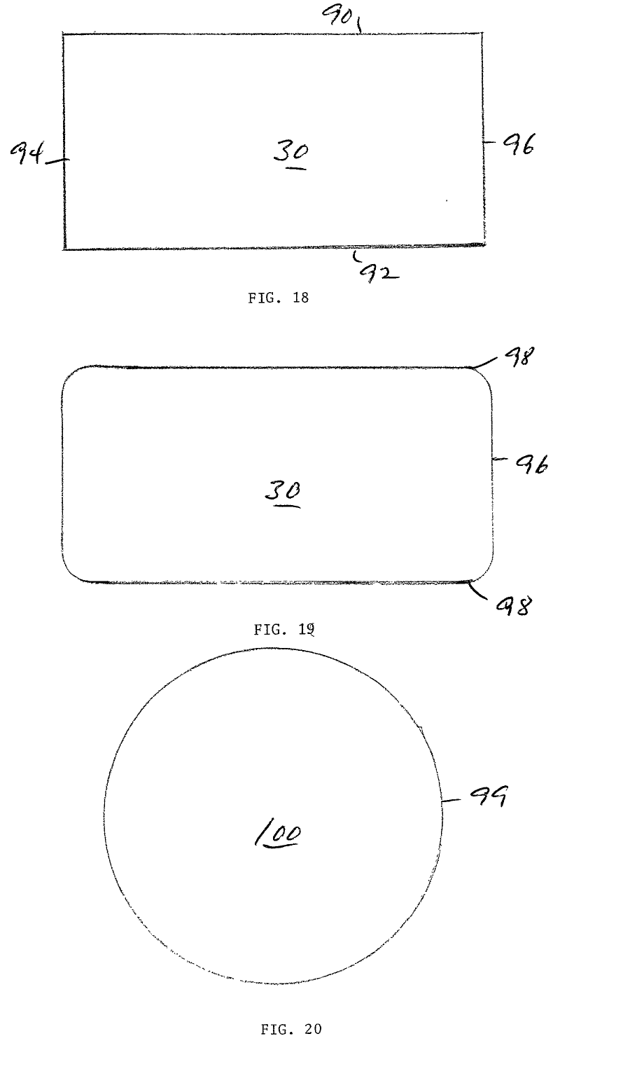

FIGS. 18-20 illustrate, in top view, several configurations for the antenna elements 30 and 32, etc. FIG. 18 shows the same configuration as is illustrated in FIG. 6: a rectangular antenna element 30 with two straight edge portions 90 and 92 which are substantially twice as long as the straight edge portions 94 and 96. FIG. 19 shows how this configuration may be varied by providing rounded corners 98 between the straight edge portions 94 and 96, etc.

Finally, FIG. 20 shows an antenna element 100 with a circular circumferential edge 99. Other configurations of antenna elements will occur to those skilled in the art.

There has thus been shown and described a novel low profile, planar, slot antenna which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A low profile, planar antenna comprising, in combination:
(a) a substantially rectangular, electrically conductive, planar, first antenna element, said first antenna element having two planar face sides and an outer circumferential edge;
(b) an electrically conductive, planar, second antenna element, having substantially the same shape and size as said first antenna element, said second antenna element having two planar face sides and an outer circumferential edge and being disposed adjacent to and parallel with said first antenna element with the respective edges of said first and second antenna elements in substantial alignment;
(c) a first electrically conductive element connected between two adjacent edges of said first and second antenna elements; and
(d) a coupling element for applying RF energy to said first antenna element at a feed point thereon;
whereby the space between adjacent edges of said first and second antenna elements forms a slot and emits radiation outward primarily in a plane parallel to the planes of each of said first and second antenna elements and with a polarization in the E field substantially normal to such two planes.

2. The antenna recited in claim 1, wherein the circumferential edge of each of said first and second antenna elements includes a plurality of substantially straight edge portions.

3. The antenna recited in claim 1, wherein the circumferential edge of each of said first and second antenna elements includes four substantially straight edge portions.

4. The antenna recited in claim 3, wherein each of said first and second antenna elements forms a parallelepiped.

5. The antenna recited in claim 3, wherein each of said first and second antenna elements forms a rectangular parallelepiped.

6. The antenna recited in claim 5, wherein two opposite edge portions of each of said first and second antenna elements are longer than the remaining two edge portions thereof,
whereby said first and second antenna elements each have two long edge portions and two short edge portions.

7. The antenna recited in claim 6, wherein the length of the long edge portions of said first and second antenna elements is substantially twice the length of the short edge portions thereof.

8. The antenna recited in claim 6, wherein the short edge portions of said first and second antenna elements have a length which is approximately one quarter of the wavelength of radiation in free space at the frequency of said RF energy.

9. The antenna recited in claim 6, wherein said first electrically conductive element is connected between a long edge portion of said first antenna element and a long edge portions of said second antenna element.

10. The antenna recited in claim 2, wherein said first electrically conductive element is an electrically conductive, planar member that extends between said first and second antenna elements in substantially perpendicular relationship thereto.

11. The antenna recited in claim 10, wherein said planar member extends between said first and said second antenna elements for the entire length of said two adjacent straight edge portions thereof.

12. The antenna recited in claim 10, wherein said planar member extends between said first and said second antenna elements for less than the entire length of said two adjacent edge portions thereof.

13. The antenna element recited in claim 12, wherein said planar member is disposed substantially midway between opposite ends of said two adjacent edge portions.

14. The antenna recited in claim 1, wherein said first electrically conductive element is adjusted by width to cause the said antenna to be at or near resonance for a particular order of resonant mode.

15. The antenna recited in claim 1, wherein said coupling element provides a ground connection to said second antenna element.

16. The antenna recited in claim 1, wherein said feed point on said first antenna element is at a point of low electric field between said first and second antenna elements.

17. The antenna recited in claim 16, wherein said feed point is at substantially the center of said first antenna element.

18. The antenna recited in claim 16, wherein said feed point is adjacent to an edge portion of said first antenna element to which said first electrically conductive element is attached.

19. The antenna recited in claim 16, wherein said feed point is adjacent to an edge portion of said first antenna element which is opposite to the edge portion to which said first electrically conductive element is attached.

20. The antenna recited in claim 1, wherein said coupling element is selected from the group consisting of a strip-line, a magnetic coupling, a loop and a hook.

21. The antenna recited in claim 1, wherein said coupling element includes at least one impedance matching element.

22. The antenna recited in claim 21, wherein said impedance matching element matches impedance over a frequency band of the RF energy which will be applied to the antenna.

23. The antenna recited in claim 1, further comprising a dielectric material disposed in the space between said first and said second antenna elements.

24. The antenna recited in claim 1, further comprising a plastic foam material disposed in the space between said first and said second antenna elements.

25. The antenna recited in claim 1, wherein said first antenna element includes a longitudinal slot extending parallel to the edge portion thereof to which said first electrically conductive element is connected.

26. The antenna recited in claim 1, wherein said second antenna element includes a longitudinal slot extending parallel to the edge portion thereof to which said first electrically conductive element is connected.

27. The antenna recited in claim 1, wherein each of said first and said second antenna element, respectively, includes a longitudinal slot extending parallel to the edge portion thereof to which said first electrically conductive element is connected.

28. The antenna recited in claim 10, wherein said planar member includes a longitudinal slot extending parallel to the edge portions of said first and second antenna elements to which said planar member is connected.

29. The antenna recited in claim 28, wherein said slot is wider at its two extremities than at its center.

30. The antenna recited in claim 2, wherein the edge portions the antenna elements extending between the substantially straight edge portions thereof are substantially rounded.

31. The antenna recited in claim 1, wherein a at least one coplanar resonant element is placed in the proximity of the edge of an antenna element to increase the bandwidth of said antenna.

32. The antenna recited in claim 1, wherein a plurality coplanar resonant elements are placed in the proximity of the edge of an antenna element to increase the bandwidth of said antenna.

33. The antenna recited in claim 32, wherein said resonant elements are selected so as to provide a multi-band antenna.

34. The antenna recited in claim 1, further comprising:
an electrically conductive, planar, third antenna element, having substantially the same shape and size as said first and second antenna elements, said third antenna element having two planar face sides and a circumferential edge and being disposed adjacent to and parallel with said first antenna element, on a side thereof opposite to said second antenna element, with the respective edges of said first and third antenna elements in substantial alignment;
an electrically conductive, planar, fourth antenna element, having substantially the same shape and size as said first, second and third antenna elements, said fourth antenna element having two planar face sides and a circumferential edge and being disposed adjacent to and parallel with said second antenna element, on a side thereof opposite to said first antenna element, with the respective edges of said second and fourth antenna elements in substantial alignment; and
a second electrically conductive element connected between two adjacent edges of said third and fourth antenna elements.

35. The antenna recited in claim 34, wherein said two adjacent edges of said third and fourth antenna elements to which said second electrically conductive element is connected are immediately adjacent and parallel to said two adjacent edges of said first and second antenna elements to which said first electrically conductive element is connected.

36. The antenna recited in claim 1, further comprising:
an electrically conductive, planar, fifth antenna element, having substantially the same shape and size as said first, second, third and fourth antenna elements, said fifth antenna element having two planar face sides and a circumferential edge and being disposed adjacent to and parallel with said third antenna element, on a side thereof opposite to said first antenna element, with the respective edges of said third and fifth antenna elements in substantial alignment;
an electrically conductive, planar, sixth antenna element, having substantially the same shape and size as said first, second, third, fourth and fifth antenna elements, said sixth antenna element having two planar face sides and a circumferential edge and being disposed adjacent to and parallel with said fourth antenna element, on a side thereof opposite to said second antenna element, with the respective edges of said fourth and sixth antenna elements in substantial alignment; and
a third electrically conductive element connected between two adjacent edges of said fifth and sixth antenna elements.

37. The antenna recited in claim 36, wherein said two adjacent edges of said fifth and sixth antenna elements to which said third electrically conductive element is connected are immediately adjacent and parallel to said two adjacent edges of said first and second antenna elements to which said first electrically conductive element is connected and of said third and fourth antenna elements to which said second electrically conductive element is connected.
